(19) United States
(12) Patent Application Publication
(10) Pub. No.: US 2013/0204597 A1
(43) Pub. Date: Aug. 8, 2013

(54) SYSTEMS AND METHODS FOR PRODUCT PERFORMANCE AND PERCEPTION MODELING

(71) Applicant: The Procter & Gamble Company, Cincinnati, OH (US)

(72) Inventors: Karl Depta, Bad Vilbel (DE); Peter Franz Nobis, Frankfurt am Main (DE); Bernd Stassen, Idstein (DE); Reiner Engelmohr, Egelsbach (DE); Joachim Wilhelm, Eschborn (DE); Alexander Franz Doll, Kronberg (DE); Karen Lynn Claire-Zimmet, Kronberg (DE); Roxana Von Koppenfels, Wiesbaden (DE); Frank Kressmann, Eschborn (DE); Michael Wolf, Bad Vilbel (DE)

(73) Assignee: THE PROCTER & GAMBLE COMPANY, Cincinnati, OH (US)

(21) Appl. No.: 13/759,681

(22) Filed: Feb. 5, 2013

Related U.S. Application Data
(60) Provisional application No. 61/596,527, filed on Feb. 8, 2012.

(51) Int. Cl. G06F 17/50

(52) U.S. Cl. CPC G06F 17/5009
USPC 703/6

(57) ABSTRACT

Included are embodiments of product performance and perception modeling. At least some embodiments include receiving a product geometry for a simulated toothbrush, the product geometry defining a physical product characteristic of the simulated toothbrush, receiving an environmental geometry for a simulated mouth, the environmental geometry defining a physical mouth characteristic and a perspective characteristic of the simulated mouth, and applying a simulated plaque indication layer in the simulated mouth. Similarly, some embodiments include applying a predetermined brushing stroke of the simulated toothbrush in the simulated mouth, determining sensory performance of the simulated toothbrush from the predetermined brushing stroke, and generating a scorecard indicating the sensory performance of the simulated toothbrush.

### FIELD OF THE INVENTION

The present application relates generally to product performance and perception modeling and specifically to embodiments for simulating the performance and feel of a product, such as a manual and/or powered toothbrush, on a user.

### COLOR DRAWINGS

This patent application publication or issued patent contains at least one drawing executed in color. Copies of this patent application publication or issued patent with color drawings will be provided by the Office upon request and payment of the necessary fee.

### BACKGROUND OF THE INVENTION

In many product designs, the current workflow for bringing the product to market is to first develop a design and create a physical prototype. Once the prototype is created, the prototype may be tested for performance. If the prototype does not function as desired, the design may be altered and a new prototype may be created. This iterative approach may continue until a final design is created that exhibits the desired performance characteristics. While such an approach may eventually lead to the desired design, this approach is often costly, time consuming, due to the potentially high number of prototypes that must be designed, created, and tested.

### SUMMARY OF THE INVENTION

Included are embodiments of a method for product performance and perception modeling. At least some embodiments include receiving a product geometry for a simulated toothbrush, the product geometry defining a physical product characteristic of the simulated toothbrush, receiving an environmental geometry for a simulated mouth, the environmental geometry include surface area parameters, volumetric parameters, and/or other parameters may define a physical mouth characteristic and a perspective characteristic of the simulated mouth, and applying a simulated plaque indication layer in the simulated mouth. Similarly, some embodiments include applying a predetermined brushing stroke of the simulated toothbrush in the simulated mouth, determining sensory performance of the simulated toothbrush from the predetermined brushing stroke, and generating a scorecard indicating the sensory performance of the simulated toothbrush.

Also included are embodiments of a system. Some embodiments of the system include a memory component that stores logic that, when executed by the system receives a product geometry for a simulated product, the product geometry defining a physical product characteristic of the simulated product, and receives an environmental geometry for a simulated environment, the environmental geometry defining a physical environment characteristic and a perspective characteristic of the simulated environment. Similarly, in some embodiments, the logic causes the system to apply a predetermined action of the simulated product in the simulated environment, determine sensory performance of the simulated product from the predetermined action, and generate a scorecard indicating the sensory performance of the simulated product.

Also included are embodiments of a non-transitory computer-readable medium. Some embodiments of the non-transitory computer-readable medium store a computer program that, when executed by a computing device, receives a product geometry for a simulated toothbrush, the product geometry defining a physical toothbrush characteristic of the simulated toothbrush. Some embodiments cause the computing device to receive an environmental geometry for a simulated mouth, the environmental geometry defining a physical mouth characteristic and a perspective characteristic of the simulated mouth, and apply a simulated plaque indication layer in the simulated mouth. In some embodiments, the program causes the computing device to apply a predetermined brushing stroke of the simulated toothbrush in the simulated mouth, determine plaque removal performance of the simulated toothbrush from the predetermined brushing stroke, determine sensory performance of the simulated toothbrush from the predetermined brushing stroke, and generate a scorecard indicating the plaque removal performance and the sensory performance of the simulated toothbrush.

### BRIEF DESCRIPTION OF THE DRAWINGS

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate various embodiments described herein, and together with the description serve to explain the principles and operations of the claimed subject matter.

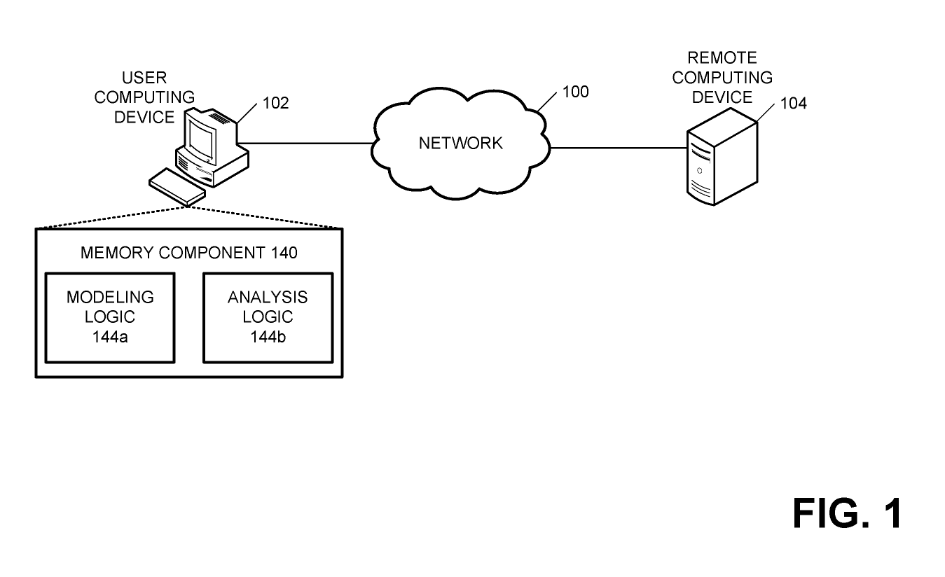

FIG. 1 depicts a computing environment for product performance and perception modeling, according to embodiments disclosed herein;

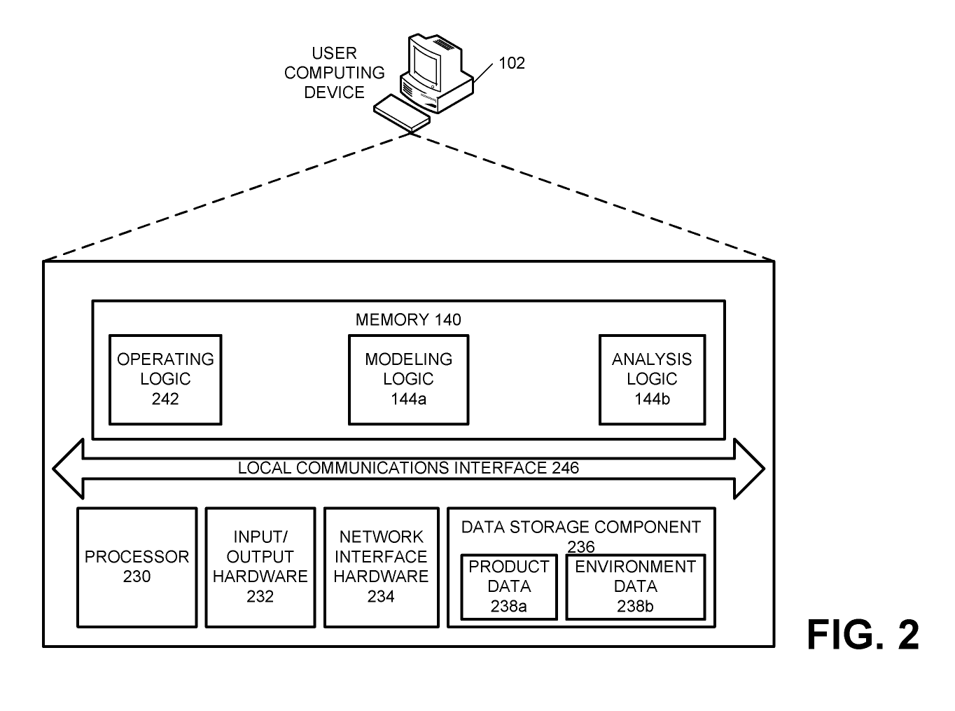

FIG. 2 depicts a computing device for product performance and perception modeling, according to embodiments disclosed herein;

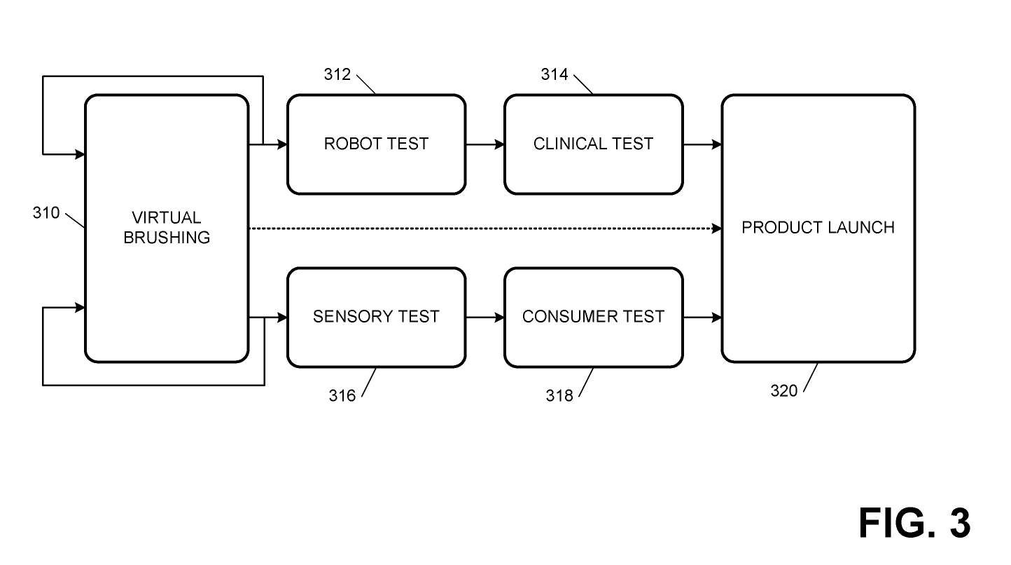

FIG. 3 depicts a flow diagram illustrating a workflow that may be utilized for product performance and perception performance, according to embodiments disclosed herein;

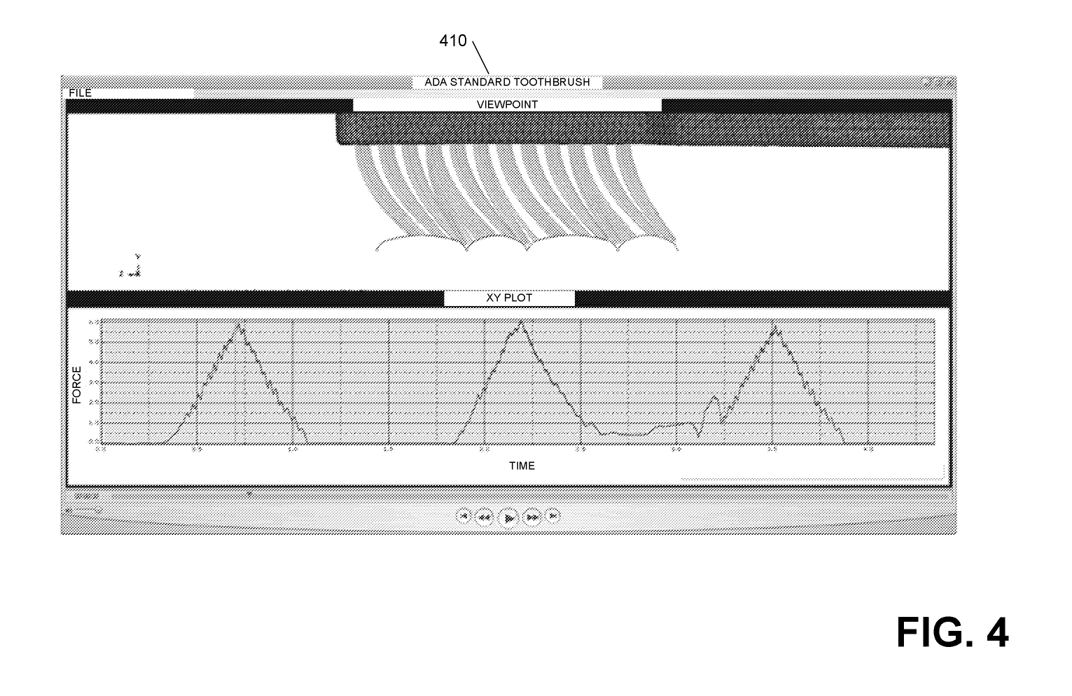

FIG. 4 depicts a user interface that may be provided for comparing a product design of a toothbrush with an American Dental Association (ADA) standard toothbrush, according to embodiments disclosed herein;

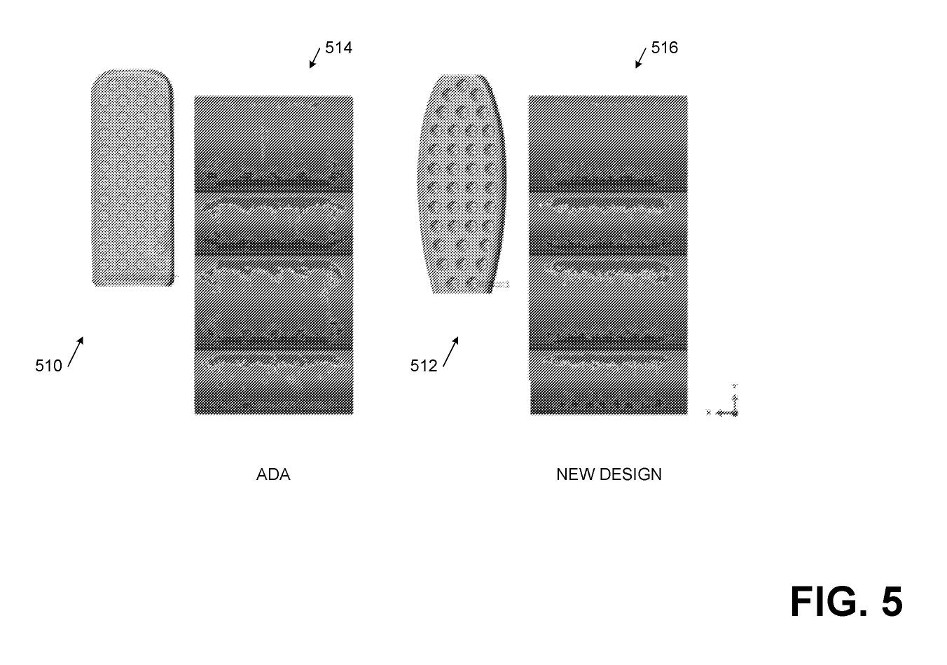

FIG. 5 depicts a graphical representation of cleaning capabilities of an ADA standard toothbrush, versus an another brush design, according to embodiments disclosed herein;

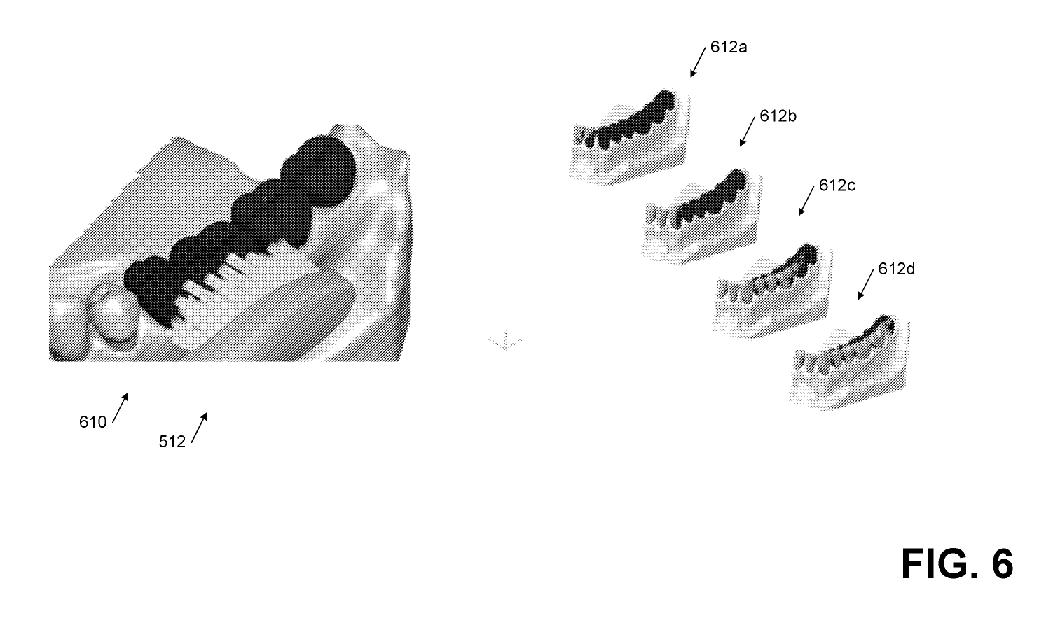

FIG. 6 depicts a graphical representation of cleaning capabilities of a toothbrush design on a simulated consumer mouth, according to embodiments disclosed herein;

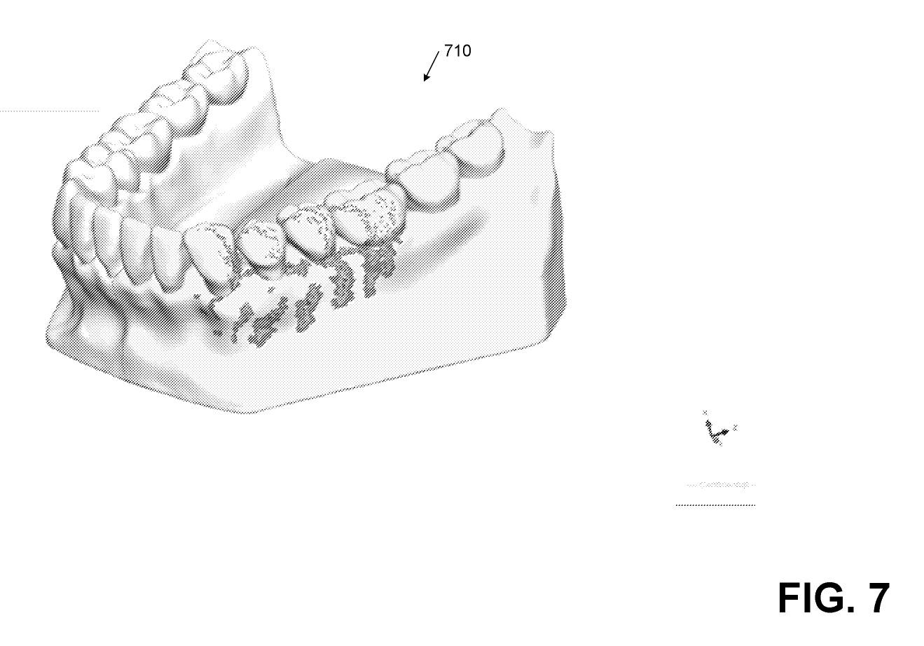

FIG. 7 depicts a graphical representation product perception of a user with the toothbrush design, according to embodiments disclosed herein;

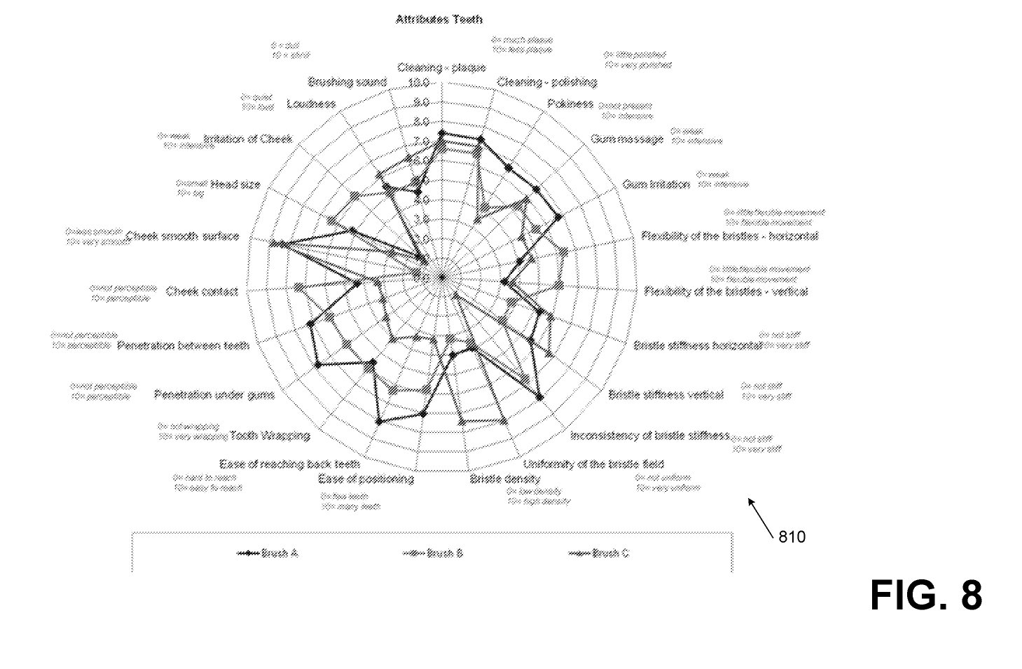

FIG. 8 depicts a consumer perception graph indicating various features of a product design and the effect those features have on the consumer perception, according to embodiments disclosed herein;

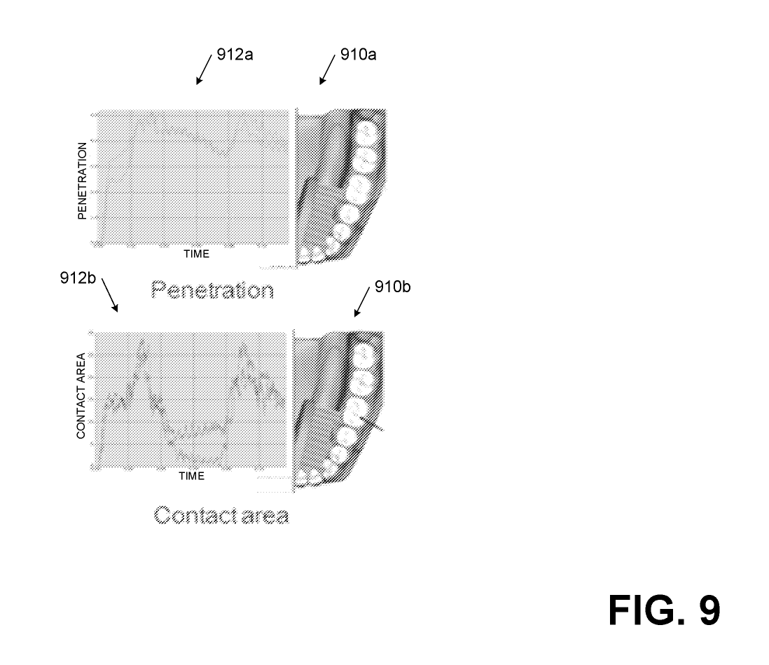

FIG. 9 depicts a plurality of graphs indicating performance of a product in a simulated environment, according to embodiments disclosed herein;

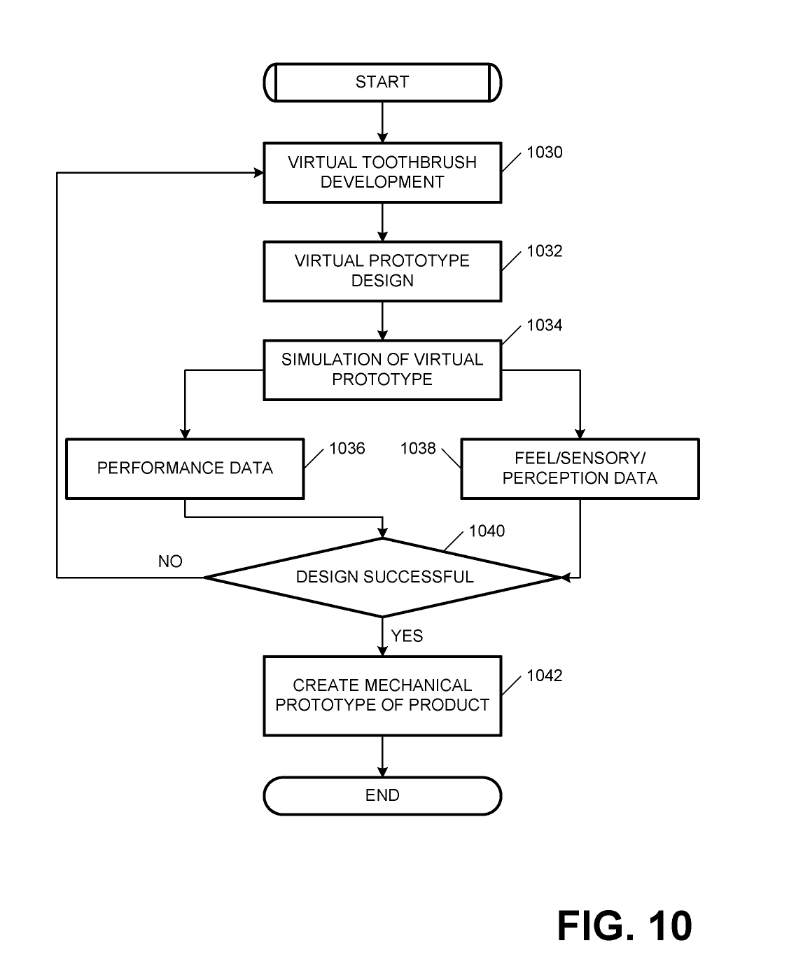

FIG. 10 depicts a flowchart for creating a prototype of a toothbrush, according to embodiments herein;

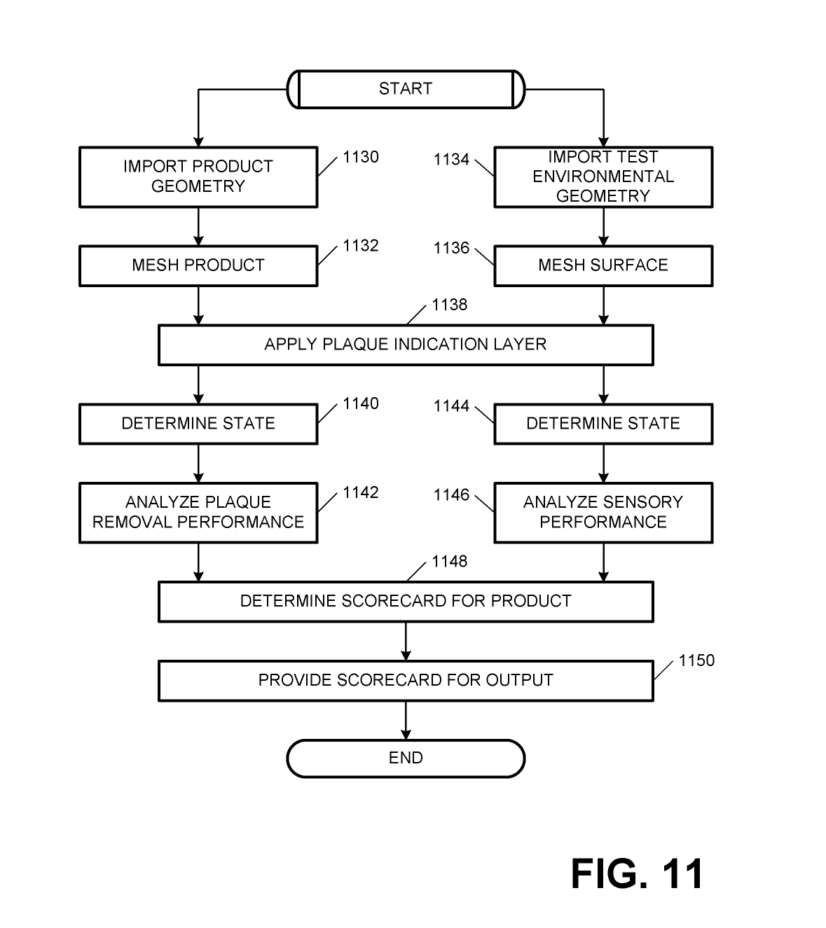

FIG. 11 depicts a flowchart for providing a product simulation and performance of that simulation, according to embodiments disclosed herein;

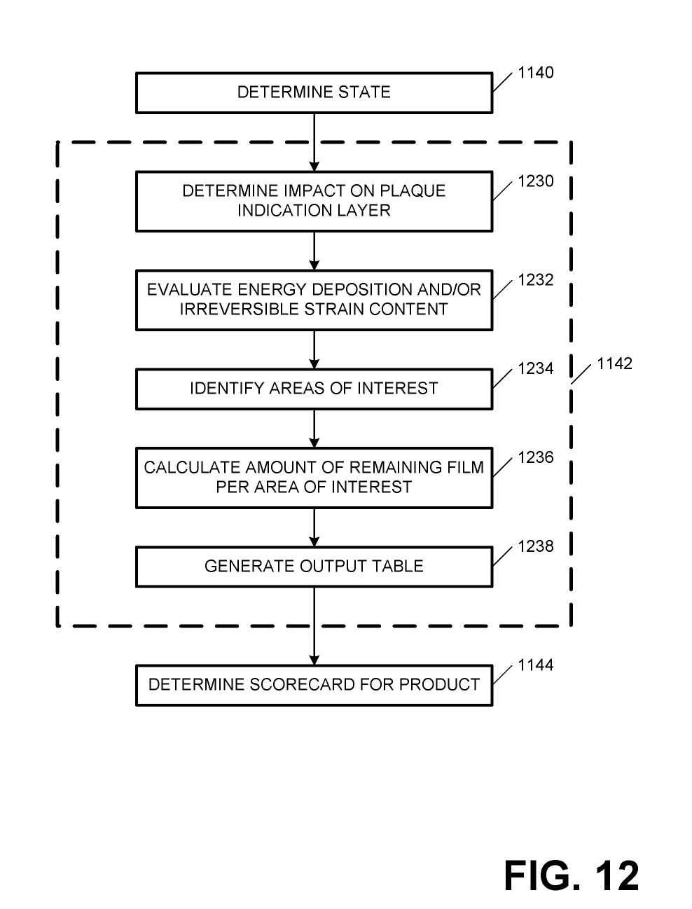

FIG. 12 depicts a flowchart for analyzing plaque removal performance, according to embodiments disclosed herein;

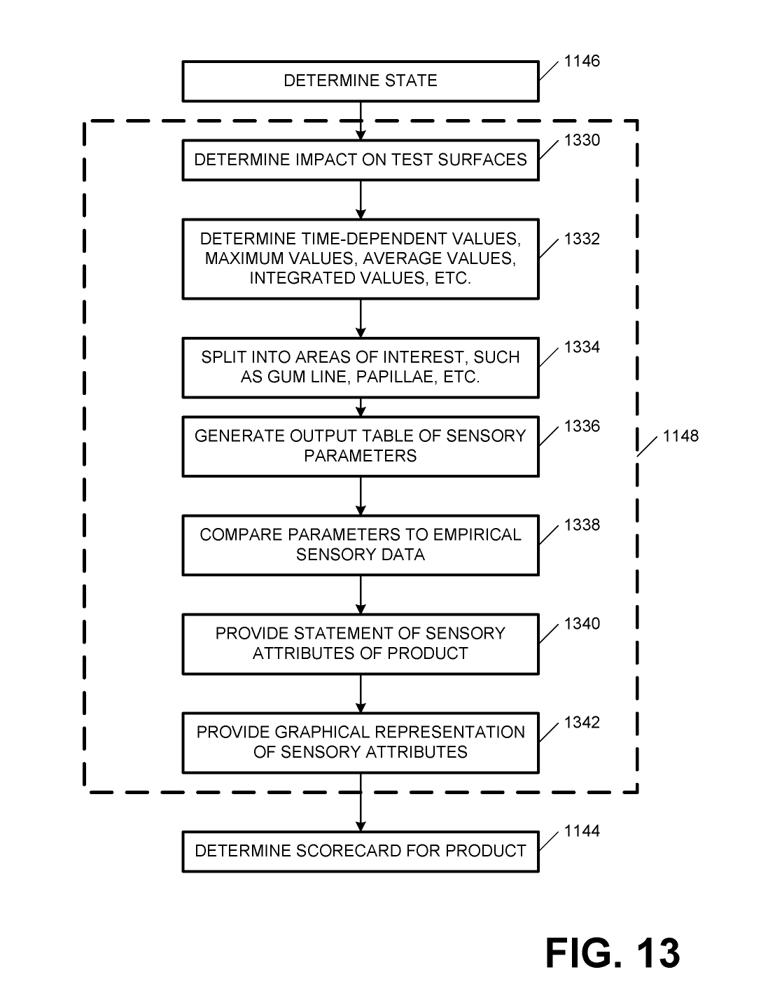

FIG. 13 depicts a flowchart for analyzing sensory performance, according to embodiments disclosed herein; and

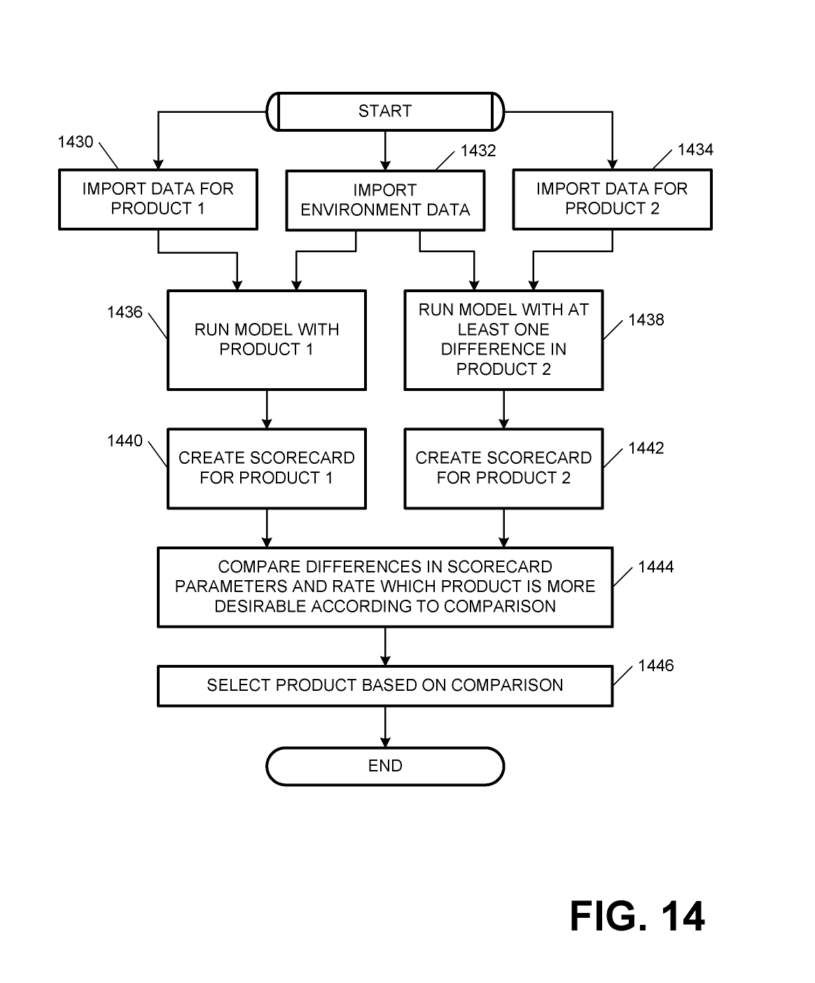

FIG. 14 depicts a flowchart for comparing a plurality of different product designs, according to embodiments disclosed herein.

### DETAILED DESCRIPTION OF THE INVENTION

Embodiments disclosed herein include systems and methods for product performance and perception modeling. More specifically, embodiments disclosed herein model and simulate the user actions, such as the tooth brushing process. Accordingly, some embodiments combine a number of different methods, such as finite element method (FEM), sophisticated material models, and computational capability to replicate and predict the behavior of cleaning elements, filaments, tufts, parts of a brush head pattern, and the whole toothbrush on (defined) test environments (test plates), hard tissues (teeth), soft tissues (gum, tongue) and combinations thereof (jaws, typodonts, dentures, etc.). As such, embodiments disclosed herein allow a product designer to efficiently analyze arbitrary cleaning elements and their properties. Examples include filaments, tuft pattern, brush configurations, etc. during the design process. With this information, embodiments calculate the mechanical interaction of cleaning elements with each other and given surfaces in the environment. Thus, embodiments allow for the development of products, such as toothbrushes, that show superior attributes in terms of performance and in-mouth perception.

Referring now to the drawings, FIG. 1 depicts a computing environment for product performance and perception modeling, according to embodiments disclosed herein. As illustrated, the computing environment may include a network 100, a user computing device 102, and a remote computing device 104. The network 100 may include a wide area network, such as the Internet, a local area network (LAN), a mobile communications network, a public service telephone network (PSTN) and/or other network and may be configured to electronically couple a user computing device 102 and a remote computing device 104.

Similarly, the user computing device 102 may include a mobile or non-mobile computer, such as a personal computer, laptop, tablet, mobile phone, etc. Regardless, the user computing device 102 may include a memory component 140, which includes modeling logic 144a and analysis logic 144b. As discussed in more detail below, the modeling logic 144a and the analysis logic 144b may be configured to cause the user computing device 102 to generate and/or receive modeling data from the remote computing device 104, as well as perform simulations to determine the performance and feel of a product, such as a toothbrush.

The remote computing device 104 may be configured to store and/or provide modeling information for the user computing device 102. Depending on the particular embodiment, the remote computing device 104 may store models of a consumer mouth, face, and/or other portion of a consumer's body. The models may then be accessed by the user computing device 102 for analysis. Similarly, the user computing device 102 may store and/or generate this information and need not access the remote computing device 104.

It should be understood that while the user computing device 102 and the remote computing device 104 are depicted as personal computers and/or servers, these are merely examples. In some embodiments, any type of computing device (e.g. mobile computing device, personal computer, server, etc.) may be utilized for any of these components. Additionally, while each of these computing devices is illustrated in FIG. 1 as a single piece of hardware, this is also an example. Each of the computing devices 102, 104 may represent a plurality of computers, servers, databases, etc.

FIG. 2 depicts a computing device for product performance and perception modeling, according to embodiments disclosed herein. In the illustrated embodiment, the user computing device 102 includes a processor 230, input/output hardware 232, network interface hardware 234, a data storage component 236 (which stores product data 238a and environment data 238b), and the memory component 140. The memory component 140 may be configured as volatile and/or nonvolatile memory and, as such, may include random access memory (including SRAM, DRAM, and/or other types of RAM), flash memory, registers, compact discs (CD), digital versatile discs (DVD), and/or other types of non-transitory computer-readable mediums. Depending on the particular embodiment, these non-transitory computer-readable mediums may reside within the user computing device 102 and/or external to the user computing device 102.

Additionally, the memory component 140 may be configured to store operating logic 242, the modeling logic 144a, and the analysis logic 144b, each of which may be embodied as a computer program, firmware, and/or hardware, as an example. A local communications interface 246 is also included in FIG. 2 and may be implemented as a bus or other interface to facilitate communication among the components of the remote computing device 104.

The processor 230 may include any processing component operable to receive and execute instructions (such as from the data storage component 236 and/or memory component 140). The input/output hardware 232 may include and/or be configured to interface with a monitor, keyboard, mouse, printer, camera, microphone, speaker, and/or other device for receiving, sending, and/or presenting data. The network interface hardware 234 may include and/or be configured for communicating with any wired or wireless networking hardware, an antenna, a modem, LAN port, wireless fidelity (Wi-Fi) card, WiMax card, mobile communications hardware, and/or other hardware for communicating with other networks and/or devices. From this connection, communication may be facilitated between the user computing device 102 and other computing devices.

Similarly, it should be understood that the data storage component 236 may reside local to and/or remote from the user computing device 102 and may be configured to store one or more pieces of data for access by the user computing device 102 and/or other components. In some embodiments, the data storage component 236 may be located remotely from the user computing device 102 and thus may be accessible via the network 100. In some embodiments however, the data storage component 236 may merely be a peripheral device, but external to the remote computing device 104.

Included in the memory component 140 are the operating logic 242, the modeling logic 144a and the analysis logic 144b. The operating logic 242 may include an operating system and/or other software for managing components of the user computing device 102. Similarly, the modeling logic 144a may be configured to cause the user computing device 102 generate a model of a product and/or environment, such as a consumer's mouth. It should be understood that the consumer's mouth may refer to any consumer, regardless of age, gender, health, etc. Similarly, in some embodiments, different consumer mouths may be tested to determine the applicability to a variety of different consumers.

In some embodiments, the modeling logic 144a may be configured to facilitate communication with the remote computing device 104 to retrieve data and/or models of a product or environment. Additionally, analysis logic 144b may reside in the memory component 140 and may be configured to cause the processor 230 to receive the product model and/or the environment model and determine the performance and feel of the product.

It should be understood that the components illustrated in FIG. 2 are merely exemplary and are not intended to limit the scope of this disclosure. While the components in FIG. 2 are illustrated as residing within the user computing device 102, this is merely an example. In some embodiments, one or more of the components may reside external to the computing device 102. It should also be understood that, while the user computing device 102 in FIGS. 1 and 2 is illustrated as a single system, this is also merely an example. In some embodiments, the modeling functionality is implemented separately from the analysis functionality, which may be implemented with separate hardware, software, and/or firmware.

FIG. 3 depicts a flow diagram illustrating a workflow that may be utilized for product performance and perception performance, according to embodiments disclosed herein. As illustrated in the virtual brushing block 310, a virtual product and/or environment may be created and tested. More specifically, the environment models may be retrieved from a known location and/or generated from imaging technologies, such as MRI (magnetic resonance imaging) images, computed tomography (CT) images etc. If the product is a toothbrush and the environment is a consumer mouth, the toothbrush can be applied with a predetermined brushing stroke to simulate a consumer brushing their teeth. The computing device 102 may then determine both the brushing performance and consumer feel, as described in more detail below. If the brushing performance and/or consumer feel do not meet a predetermined threshold, the product design may be altered to improve these parameters.

Once the virtual product meets the predetermined thresholds, a robot test 312 as well as a sensory test 316 may be performed. These tests include creating a physical prototype of the product design and utilizing the prototype. The robot test 312 may include utilizing the prototype in a robot and robot mouth to determine brushing performance The robot will brush the robot mouth in one or more predetermined brushing patterns and determine how much of an applied simulated plaque indication layer was removed. The sensory test 316 includes a human use of the prototype to determine pressure, stiffness, etc. of the prototype and thus determine a perceived feel of the prototype. Additionally, a clinical test 314 may be performed to further determine product performance. The clinical test may include utilizing human test subjects to use the prototype and determine how well the prototype performs. Similarly, the consumer test 318 may also include utilizing human test subjects to use the prototype to determine how the product feels. If the prototype passes the tests in blocks 312-318, the product may be launched in block 320. If not, the process may return to the virtual brushing block 310 for redesign.

It should be understood that while some embodiments are configured to perform the actions depicted in blocks 312-318, some embodiments may be configured to proceed directly from virtual brushing in block 310 to product launch in block 320. More specifically, in many scenarios the product design created in block 310 may be accurate enough that one or more of the blocks 312-318 are unnecessary.

FIG. 4 depicts a user interface 410 that may be provided for comparing a product design of a toothbrush with an American Dental Association (ADA) standard toothbrush, according to embodiments disclosed herein. As illustrated, an ADA standard toothbrush 510 is generally rectangular in head cross section, with uniform bristle tufts, as depicted in FIG. 5. Additionally, the ADA standard toothbrush 510 has been determined to provide a predetermined performance threshold to which “ADA approved” toothbrushes must comply. As illustrated in the graph depicted in the user interface 410, one mechanism for reaching the desired performance includes a force versus time graph as plotted. In some embodiments, the force is measured as a total normal force on the test surface.

FIG. 5 depicts a graphical representation of cleaning capabilities of an ADA standard toothbrush 510, versus another brush design, according to embodiments disclosed herein. More specifically, in embodiments disclosed herein, the ADA standard toothbrush 510 may be modeled by the user computing device 102 (or other computing device). The modeled toothbrush may resemble a physical prototype so that testing of the toothbrush may be as accurate as possible. Additionally, a consumer mouth may be modeled. While in some embodiments, the consumer mouth model may be stored and accessed by the user computing device 102, in some embodiments, the user computing device 102 may access MRI images to generate a 3-dimensional model of a consumer mouth with finite element analysis. With the modeled ADA standard toothbrush 510 and the modeled consumer mouth, a known brushing technique or action may be applied. Additionally, an area of interest (or a plurality of areas of interest) in the simulated consumer mouth 610 may be identified and an analysis may be performed to determine performance of the prototype.

As illustrated in the example of FIG. 5, the simulated ADA standard toothbrush 510 was shown to have a performance as illustrated in the area of interest depiction 514, with red representing areas of coverage above a predetermine threshold and blue representing areas of coverage below a predetermined threshold (which may or may not be different thresholds). In designing a new toothbrush (or other product), the developer may first create a simulated toothbrush. The simulated new toothbrush 512 may include a head design and a handle design and may then be applied to the simulated consumer mouth using the known brushing technique. As illustrated, the performance of the new simulated toothbrush may be illustrated in the area of interest depiction 516. The new simulated toothbrush may be a powered toothbrush or a manual toothbrush. The area of interest depiction illustrates that areas of red have the highest plaque removal performance (and thus the highest performance), while areas of blue have the lowest plaque removal performance. A comparison may then be made with the simulated ADA standard toothbrush 510 to determine whether the simulated new toothbrush 512 meets ADA standards. If the simulated new toothbrush 512 meets or exceeds the simulated performance test requirements, the simulated new toothbrush 512 may then be tested for consumer perception. If not, the simulated new toothbrush 512 may be redesigned and retested.

FIG. 6 depicts a graphical representation of cleaning capabilities of the simulated new toothbrush 512 on a simulated consumer mouth 610, according to embodiments disclosed herein. As discussed above, the simulated new toothbrush 512 may be applied to the simulated consumer mouth 610 in a known brushing technique. The area of interest (depicted in blue) may be focused upon to determine the performance of the simulated new toothbrush 512. As also illustrated, the performance may be determined over time, where simulation 612a is captured at time t₁; simulation 612b is captured at time t₂; simulation 612c is captured at t₃; and simulation 612d is captured at t₄. If it is determined that the simulated new toothbrush 512 meets a predetermined threshold for performance, the analysis may proceed to determining consumer perception of the simulated new toothbrush 512. If not, the new simulated toothbrush may be redesigned.

It should be understood that in some embodiments, design (or redesign) of the simulated new toothbrush 512 may be performed via the user computing device 102. More specifically, the toothbrush designer may be provided with a plurality of options regarding sizes, shapes, materials, etc. for designing the new simulated toothbrush. Additionally, with the various options, other information may be provided, such as hardness, bristle pliability, etc. Thus, if a first simulated new toothbrush 512 is designed with that material, but does not exhibit adequate performance qualities; one option may be for the toothbrush designer to select a bristle material with a higher number of filaments.

FIG. 7 depicts a graphical representation of product perception of a user with the simulated new toothbrush 512, according to embodiments disclosed herein. As illustrated, some embodiments may determine consumer perception in addition to or as a substitute for the performance analysis, discussed above). Consumer perception may include how the product will feel to a consumer. As an example, depending on a particular design and/or materials of a toothbrush, the bristles of the toothbrush may actually cause lacerations in a consumer's gums. As such a consequence would be undesirable; the modeling techniques described herein may be utilized for determining when a consumer will likely identify the new toothbrush design as uncomfortable.

Accordingly, the embodiment of FIG. 7 depicts a simulated consumer mouth 610 with pressure indicators depicted via a plurality of different colors. Generally speaking, the higher the pressure above a predetermined threshold, the less desirable the feel of a toothbrush. As the gums may be sensitive and may erode over time due to brushing, one objective of the toothbrush design is to reduce unnecessary pressure on the gums. Thus, if it appears that the current toothbrush design creates excessive pressure on the gums, the toothbrush design may be redesigned with a different material and/or shape to reduce this pressure.

It should be understood that while the description above for FIG. 7 refers to pressure on the simulated consumer mouth 610, this is merely an example. More specifically, other criteria may be analyzed to determine consumer perception. Examples include feeling, irritation pokiness, gum irrigation, gum massage, bristle stiffness horizontal, bristle stiffness vertical, penetration under gums, penetration between teeth, etc., which may derived from the brush perspective criteria.

FIG. 8 depicts a consumer perception graph indicating various features of a product design, according to embodiments disclosed herein. As illustrated, in response to simulating bushing and identifying consumer perception, the spider graph 810 of FIG. 8 may be created. The spider graph 810 identifies cleaning plaque, cleaning polishing, pokiness, gum massage, gum irritation, flexibility of the bristles horizontal, flexibility of the bristles vertical, bristle stiffness horizontal, bristle stiffness vertical, inconsistency of bristle stiffness, uniformity of the bristle field, bristle density, ease of positioning, ease of reaching back teeth, tooth wrapping, penetration under gums, penetration between teeth, cheek contact, cheek smooth surface, head size, irritation of cheek, loudness, and brushing sound. These criteria can identify brush performance, bristle deformation, contact pressure, and/or other reasons for the consumer perception. If one or more negative consumer perception criteria are above a predetermined threshold or positive criteria are below a predetermined threshold, the new simulated toothbrush may be redesigned to alter that perception.

FIG. 9 depicts a plurality of graphs indicating performance of a product in a simulated environment 910, according to embodiments disclosed herein. As illustrated, in the simulated environment 910a, a determination may be made regarding interdental penetration and/or gingival pocket penetration. In graph 912a, the interdental penetration and/or gingival pocket penetration may be displayed at various times of the brush cycle, with a comparison of the new simulated toothbrush and an ADA simulated toothbrush (or other control group). Similarly, in the simulated environment 910b, contact area may be determined and graphed with regard to a control group in the graph 912b. This information may provide yet another tool for determining the consumer perception of the new simulated toothbrush 512.

FIG. 10 depicts a flowchart for creating a prototype of a toothbrush, according to embodiments herein. As illustrated in block 1030, virtual toothbrush development may be performed. As described above, a user interface may be provided on the user computing device 102 for allowing a designer to create the new simulated toothbrush. The user interface may include one or more templates for selecting shapes, sizes, materials, etc. of the new simulated toothbrush (or other product). Additionally, the designer may alter these characteristics to create the desired simulated product. In block 1032, the virtual simulated prototype may be created. In block 1034, the virtual prototype may be simulated in a simulated environment and using a simulated, predetermined technique (such as a predetermined brushing stroke or routine). In block 1036 performance data may be determined Similarly, in block 1038, consumer perception data may be determined. In block 1040, the performance data and the consumer perception data may be utilized to determine whether the design is successful. If the design is not successful, the process returns to block 1030. If the design is successful, in block 1040, a mechanical prototype may be created for testing.

FIG. 11 depicts a flowchart for providing a product simulation and performance of that simulation, according to embodiments disclosed herein. As illustrated in block 1032, a physical product characteristic (which may be a physical toothbrush characteristic for a virtual toothbrush), such as a product geometry for a toothbrush may be imported into the user computing device 102. The physical product characteristic may include dimensions, materials, shapes, etc. of the product. In block 1032 the product geometry may be meshed to create a product or toothbrush virtual mesh (e.g., a virtual model and/or a representation of finite elements in the virtual model). In block 1034, a test environment (such as a consumer mouth) geometry may be imported into the user computing device 102. In block 1136, the test environment may be meshed to create an environment or mouth virtual mesh (e.g., a virtual model). In block 1138, a plaque indication layer may be applied to the test environment to simulate plaque inside the mouth. The plaque indication layer may be applied to the teeth, gum line, and/or a predetermined distance from the gum line (e.g., 2 mm, above the papillae, etc.). In block 1140, a state of the virtual product may be determined to define and model a brushing procedure. In block 1142 the plaque removal performance may be determined This determination may be made on the mouth as a whole, on the teeth, and/or on an individual tooth. Similarly, in block 1144, the state of the environmental geometry may be determined, which includes defining and modeling the environmental geometry. In some embodiments, the environmental geometry may include an environment geometry and/or a volumetric geometry and/or may define a physical environment characteristic (which may include a physical mouth characteristic for a simulated consumer mouth) and a perspective characteristic of the simulated environment. As described above, the physical environment characteristic may include location of teeth, gums, dimensions of the mouth, etc. The perspective characteristic may include areas of sensitivity, areas where the mouth is fragile, etc. In block 1146, the sensory performance may be determined. In block 1148, a scorecard for the product may be determined. In block 1150, the scorecard may be provided for output.

As an example, the scorecard may provide scores for the following criteria: plaque—all surfaces (%), interdental (%), gum line tooth (%); sensory—gum line accumulated force (N), gum line maximum force (N), gum line average force (N), gum line maximum force after touchdown (N), papillae distal accumulated force (N), papillae distal maximum force (N), papillae distal average force (N), papillae distal maximum force after touchdown (N), papillae mesial accumulated force (N), papillae mesial maximum force (N), papillae mesial average force (N), papillae mesial maximum force after touchdown (N), total gum accumulated force (N), total gum maximum force (N), total gum average force (N), and total gum maximum force after touchdown (N). As indicated above, one or more of these categories may be scored for the mouth as a whole, for the teeth, and/or for an (one or more) individual tooth.

FIG. 12 depicts a flowchart for analyzing plaque removal performance, according to embodiments disclosed herein. More specifically, referring back to FIG. 11, from the determine state block 1140, the proceeds to the analyze plaque removal performance block 1142. Within block 1142, in block 1230, the impact on the plaque indication layer may be determined. In block 1132, an energy deposition, irreversible strain content, post failure material removal, area coverage, and/or an area coverage above a predetermined force threshold content may be determined. In block 1234, areas of interest may be identified. In block 1236 an amount of remaining film per area of interest may be determined to assess the plaque removal performance. In block 1238 an output table may be generated. The process may then proceed to block 1144 (FIG. 11).

FIG. 13 depicts a flowchart for analyzing sensory performance, according to embodiments disclosed herein. Referring back to FIG. 11, from block 1146, the process proceeds to block 1148. Within block 1148, in block 1330, an impact on the test environments may be determined. In block 1332, time dependent values, maximum values, average values, integrated values, force, pressure, energy friction, velocity, angle, transient behavior, and coverage, etc. may be determined for assessing the consumer perception of the product. In block 1334, the environment may be split into areas of interest, such as a gum line area, a papillae area, etc. In block 1336, an output table of sensory parameters may be generated. In block 1338, the parameters may be compared with empirical sensory data. The empirical sensory data may be retrieved from an external source and may include data associated with standard sensory data for the environment (e.g. a consumer mouth). In block 1338, the sensory parameters may be compared with the sensory data. In block 1340, a statement of sensory attributes for the product may be provided. In block 1342, a graphical representation of the sensory attributes may be provided. The process may then proceed to block 1144 (FIG. 11).

FIG. 14 depicts a flowchart for comparing a plurality of different product designs, according to embodiments disclosed herein. As illustrated in block 1430, a first product may be imported. In block 1432, environment data may be imported. In block 1434, data for a second product may be imported. In block 1436, with the first product data and the environment data, a model may be run for the first product. This model may be run similar to that described in FIG. 11. Similarly, in block 1438, a model may be run with the second product, where there is at least one difference between the first product and the second product. In block 1440 a scorecard may be created for the first product. In block 1442 a scorecard may be created for the second product. In block 1444, the difference in the scorecard parameters may be compared and a rating of which product is more desirable may be made. In block 1446, a product may be selected based on the comparison.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be understood to those skilled in the art that various other changes and modifications can be made without departing from the spirit and scope of the invention. It is therefore intended to cover in the appended claims all such changes and modifications that are within the scope of this invention.

What is claimed is:

1. A system for product performance and perception modeling, comprising:
a memory component that stores logic that, when executed by the system performs at least the following:
receive a product geometry for a simulated product, the product geometry defining a physical product characteristic of the simulated product;
receive an environmental geometry for a simulated environment, the environmental geometry defining a physical environment characteristic and a perspective characteristic of the simulated environment;
apply a predetermined action of the simulated product in the simulated environment;
determine sensory performance of the simulated product from the predetermined action; and
generate a scorecard indicating the sensory performance of the simulated product.

2. The system of claim 1, wherein the logic further causes the system to perform at least the following:
create a product virtual mesh of the simulated product; and
create an environment virtual mesh of the simulated environment.

3. The system of claim 1, further comprising analyzing plaque removal performance, wherein analyzing plaque removal performance comprises determining an impact on the simulated plaque indication layer.

4. The system of claim 1, wherein analyzing plaque removal performance comprises evaluating at least one of the following: energy deposition, irreversible strain content, post failure material removal, area coverage, and an area coverage above a predetermined force threshold.

5. The system of claim 1, wherein analyzing plaque removal performance comprises calculating an amount of remaining film per area of interest in the simulated environment.

6. The system of claim 1, wherein analyzing sensory performance comprises determining an impact on the simulated environment and wherein determining impact on the simulated environment comprises determining at least one of the following: time dependent values, maximum values, average values, integrated values, force, pressure, energy friction, velocity, angle, transient behavior, and coverage.

7. The system of claim 1, wherein analyzing sensory performance comprises splitting the simulated environment into a plurality of areas of interest.

8. The system of claim 1, wherein analyzing sensory performance comprises:
generating sensory parameters for the simulated product in the simulated environment; and
comparing sensory data parameters with empirical sensory data.

9. The system of claim 1, wherein the logic is further configured to determine product performance of the simulated product from the predetermined action.

10. A method for toothbrush performance and perception modeling, comprising:
receiving a product geometry for a simulated toothbrush, the product geometry defining a physical product characteristic of the simulated toothbrush;
receiving an environmental geometry for a simulated mouth, the environmental geometry defining a physical mouth characteristic and a perspective characteristic of the simulated mouth;
applying a simulated plaque indication layer in the simulated mouth;
applying a predetermined brushing stroke of the simulated toothbrush in the simulated mouth;
determining sensory performance of the simulated toothbrush from the predetermined brushing stroke; and
generating, by a computing device, a scorecard indicating the sensory performance of the simulated toothbrush.

11. The method of claim 10, further comprising creating a toothbrush virtual mesh of the simulated toothbrush and a mouth virtual mesh of the simulated mouth.

12. The method of claim 10, further comprising determining plaque removal performance of the simulated toothbrush from the predetermined brushing stroke.

13. The method of claim 10, wherein analyzing plaque removal performance comprises determining an impact on the simulated plaque indication layer.

14. The method of claim 10, wherein analyzing plaque removal performance comprises evaluating at least one of the following: energy deposition, irreversible strain content, post failure material removal, area coverage, and an area coverage above a predetermined force threshold.

15. The method of claim 10, wherein analyzing plaque removal performance comprises calculating an amount of remaining film per area of interest.

16. The method of claim 10, wherein analyzing sensory performance comprises determining an impact on the simulated mouth.

17. The method of claim 16, wherein determining impact on the simulated mouth comprises determining at least one of the following: time dependent values, maximum values, average values, and integrated values, force, pressure, energy friction, velocity, angle, transient behavior, and coverage.

18. The method of claim 10, wherein analyzing sensory performance comprises splitting the simulated mouth into a plurality of areas of interest.

19. The method of claim 10, wherein analyzing sensory performance comprises:
generating sensory parameters for the simulated toothbrush in the simulated mouth; and
comparing sensory data parameters with empirical sensory data.

20. A non-transitory computer-readable medium for toothbrush performance and perception modeling that stores a computer program that, when executed by a computing device, performs at least the following:
receive a product geometry for a simulated toothbrush, the product geometry defining a physical toothbrush characteristic of the simulated toothbrush;
receive an environmental geometry for a simulated mouth, the environmental geometry defining a physical mouth characteristic and a perspective characteristic of the simulated mouth;
apply a simulated plaque indication layer in the simulated mouth;
apply a predetermined brushing stroke of the simulated toothbrush in the simulated mouth;
determine plaque removal performance of the simulated toothbrush from the predetermined brushing stroke;
determine sensory performance of the simulated toothbrush from the predetermined brushing stroke;
generate a scorecard indicating the plaque removal performance and the sensory performance of the simulated toothbrush; and
utilize product geometry to create a physical prototype.
